(19) United States
(12) Patent Application Publication
(10) Pub. No.: US 2022/0143738 A1
(43) Pub. Date: May 12, 2022

(54) REFILL FRICTION STIR SPOT WELDING USING A SUPERABRASIVE TOOL

(71) Applicant: Brigham Young University, Provo, UT (US)

(72) Inventors: Yuri Hovanski, Mapleton, UT (US); John Hunt, Orem, UT (US); Brigham Larsen, Orem, UT (US)

(21) Appl. No.: 17/436,915

(22) PCT Filed: Mar. 9, 2020
(86) PCT No.: PCT/US2020/021715

§ 371 Date: Sep. 7, 2021

Related U.S. Application Data
(60) Provisional application No. 62/816,012, filed on Mar. 8, 2019.

(51) Int. Cl. B23K 20/12

(52) U.S. Cl. CPC B23K 20/123; B23K 20/1265; B23K 20/1255

(57) ABSTRACT

A refill friction stir spot welding tool comprises: a clamp; a shoulder concentric with, and articulable relative to, the clamp; and a probe concentric with, and articulable relative to, the shoulder; wherein each of the clamp, the shoulder and the probe have at least a portion made of a superabrasive material.

### CROSS-REFERENCE TO RELATED APPLICATION

This application claims the benefit of the filing date of U.S. Provisional Patent Application No. 62/816,012, filed on Mar. 8, 2019, entitled “Refill Friction Stir Spot Welding Using a Superabrasive Tool,” the disclosure of which is incorporated herein by reference.

### TECHNICAL FIELD

This document relates, generally, to refill friction stir spot welding using a superabrasive tool.

### BACKGROUND

Many manufacturing processes apply techniques for joining two or more workpieces to each other. Welding is a joining technique that sometimes involves applying high heat to melt the parts, thereby allowing them to fuse together with a durable bond. Other types of welding are instead based on softening (plasticizing) the workpieces without melting them, and these techniques are sometimes referred to as solid state welding. Solid state welding techniques include friction stir welding, for example.

The various welding techniques can be used for creating one or more types of weld that joins the workpieces. With linear welding, the weld typically extends along a linear joint. With spot welding, on the other hand, the weld is formed at a single location (e.g., as a single spot) in order to fuse the workpieces together.

### SUMMARY

In a first aspect, a refill friction stir spot welding tool comprises: a clamp; a shoulder concentric with, and articulable relative to, the clamp; and a probe concentric with, and articulable relative to, the shoulder; wherein each of the clamp, the shoulder and the probe have at least a portion made of a superabrasive material.

Implementations can include any or all of the following features. Another portion of the refill friction stir spot welding tool is made of a material other than the superabrasive material. The other material includes steel. The superabrasive material comprises diamond. The diamond comprises polycrystalline diamond. The diamond comprises synthetic diamond. The superabrasive material comprises cubic boron nitride. The cubic boron nitride comprises polycrystalline cubic boron nitride. The superabrasive material has a Vickers hardness of at least about 20 gigapascals (GPa). The superabrasive material has a Vickers hardness of at least about 60 GPa. The superabrasive material has a Vickers hardness of at least about 80 GPa.

In a second aspect, a method comprises: with a refill friction stir spot welding tool, plunging one of a shoulder or a probe into a workpiece during rotation, the refill friction stir spot welding tool comprising a clamp, a shoulder concentric with, and articulable relative to, the clamp, and a probe concentric with, and articulable relative to, the shoulder, each of the clamp, the shoulder and the probe having at least a portion made of a superabrasive material; and after plunging, refilling by advancing another one of the shoulder or the probe toward the workpiece during rotation.

Implementations can include any or all of the following features. The method further comprises preheating the workpiece before plunging, the preheating performed by contacting the workpiece with the refill friction stir spot welding tool during rotation. The method further comprises dwelling the refill friction stir spot welding tool at the workpiece after the plunging. The method further comprises performing a secondary plunge after the refilling. The superabrasive material comprises diamond. The superabrasive material comprises a polycrystalline superabrasive material. The superabrasive material comprises cubic boron nitride. The superabrasive material has a Vickers hardness of at least about 40 GPa. The superabrasive material has a Vickers hardness of at least about 80 GPa.

### BRIEF DESCRIPTION OF DRAWINGS

FIGS. 1A-1B show an example of a coupon arrangement.

FIGS. 2A-2C show example graphs of probe loads.

FIGS. 3A-3B show example graphs of probe loads.

FIGS. 4A-4D show example graphs of torques.

FIG. 5 shows an example graph of peak probe force.

FIG. 6 shows an example graph of weld torque.

FIG. 7 shows an example graph of average plunge spindle torque.

FIGS. 8A-8C show example graphs of shoulder and probe force.

FIG. 9 shows a bottom view of an example of a refill friction stir spot welding toolset.

FIG. 10 shows an example graph of diffusion coefficients data.

FIG. 11 shows an example graph of predictions of FeAl₃ thickness.

FIG. 12 shows an example graph of predicted diffusivity data.

FIG. 13 shows an example graph of predicted diffusivity data.

FIGS. 14A-14B show an example of a refill friction stir spot welding toolset.

FIG. 15 shows an example of a refill friction stir spot welding toolset.

FIG. 16 shows an example of a method.

### DETAILED DESCRIPTION

The present disclosure relates to a refill friction stir spot welding (RFSSW) tool that is made at least in part of a superabrasive material, and to welding using such an RFSSW tool.

Previously proposed RFSSW processes have received relatively limited use in major manufacturing areas such as the automotive industry. This is believed to be in large part due to the fact that such RFSSW processes have cycle times (e.g., the time from beginning to form one spot weld until the beginning of the next one) that have historically had a lower limit on the order of multiple seconds per spot. Multiple experts have expressed their belief that the cycle time of RFSSW processes had a lower limit of about 2 seconds, which may render the previous RFSSW techniques impractical or unsuitable for use in modern manufacturing. The present disclosure, on the other hand, demonstrates that quality spot welds can be formed at a significantly shorter cycle time. For example, cycle times of about 800 milliseconds (ms) can be used, which may make the RFSSW technique a superior candidate in fields that are heavily reliant on spot welding, such as the automotive industry. Moreover, such previously proposed RFSSW techniques have used tools made of steel and/or tungsten carbide, which the present disclosure shows can be subject to intermetallic growth during the welding process. For example, the present disclosure shows that intermetallic growth can require the tool to be removed for cleaning as often as after a few hundred welds. Such cleaning an removal processes take significant amounts of time, which would more than exceed the gain of the shorter weld duration and therefore lead to less throughput.

The present disclosure presents new discoveries that challenge earlier claims and general sentiments regarding the potential for RFSSW to become a high-speed joining technique. The inventors have conducted an investigation of the RFSSW process to evaluate factors that have traditionally prevented RFSSW from achieving fast cycle times. For example, the relationship between cycle time and joint quality is explored, as is the relationship between design limitations of a welding machine and cycle time. Some conclusions from the performed investigation are that the rotational speed of the RFSSW tool (measured in revolutions per minute, or RPM) can have a significant influence on the load and/or the torque seen during welding. As another example, the cycle time of the RFSSW process significantly affects both the load and the torque. As another example, from a design standpoint, the plunge operation (to be described below) can form a limiting stage for torque. As another example, at least some metal workpieces that are commonly used can be joined in less than one second with weld strengths greater than 7 kilonewtons (kN). As another example, tool rotational velocity can be at least approximately inversely proportional to the load at the probe (to be described below). As another example, cycle time can be at least approximately inversely proportional to the probe load.

Referring again to the previously proposed RFSSW techniques, due to the common belief that they could not be performed significantly faster than what had previously been used, it was also believed that no reason or motivation existed for making the tools from materials other than, say, steel or tungsten carbide. With traditional friction stir welding, superabrasive tooling had been developed. However, this development was specifically to enable friction stir welding of steel and other materials with high melting temperatures. RFSSW, on the other hand, has been almost exclusively an aluminum process.

Examples herein refer to RFSSW. In RFSSW techniques, a toolset that combines three concentric tools is used to locally stir and thereby join two workpieces (e.g., two sheets), typically in a lap configuration. An RFSSW toolset can include a cylindrical probe nested inside a hollow cylindrical shoulder. The shoulder, moreover, is nested inside a cylindrical cavity of a clamp (e.g., a clamping ring). The three concentric tools can be individually articulated along a common linear axis. RFSSW can be considered equivalent to, or can also be referred to as, friction spot welding and/or refill friction spot joining. That is, RFSSW is a solid-state process that was derived from friction stir welding.

RFSSW joints can be made in a series of stages in which individual tools are rotated and translated to stir the materials to be joined. The process can include multiple stages. For example, individual stages can be described as preheating, plunging, dwelling, and refilling, respectively. More or fewer stages can be used.

The probe and shoulder can be rotated in all the above stages, and they can be rotated at the same speed as each other. In preheating, the probe and shoulder can be kept in contact with the surface of the material for a relatively brief time to increase the temperature of the weld area before joining. The inclusion or omission of a preheating stage can depend on the material being welded and/or one or more weld parameters. During the plunging stage, either the shoulder or the probe is plunged into the surface of the material to be joined. The non-plunged probe or shoulder can simultaneously be retracted in the opposite direction of the plunging tool. For example, this can allow plasticized weld material to be drawn into the toolset, similar to fluid entering a syringe. After the plunging, the toolset can be allowed to dwell in the plunged state for a relatively brief time while rotating. For example, this can increase the heat and energy input of the joint. The inclusion or omission of a dwelling stage can depend on the material being welded and/or one or more weld parameters. In the refilling stage, both the plunged and the non-plunged tool can be brought back to their initial positions. This can force the previously drawn material back out of the toolset and into the weld area, creating a relatively flush joint (e.g., similar to joints obtained with friction stir welding).

One or more stages can be performed after the refilling. For example, the probe and the shoulder can be articulated to align their front surfaces apart from the weld surface, and then relatively quickly plunged a relatively short distance into the weld. Such a secondary plunge of both the probe and shoulder can result in a relatively slight reduction in material thickness. Nevertheless, the secondary plunge can reduce weld defects and/or improve overall joint strength and quality. One publication, Zhiwu Xu et al., Refill friction stir spot welding of 5083-O aluminum alloy, Journal of Materials Science & Technology 34 (5):878-885 (2018), employed a secondary plunge sequence to produce a 0.3 mm indentation on the weld surface. They showed, through joint cross sectioning, that voids and regions of incomplete fill that were otherwise present in normal welds were eliminated by the adoption of this sequence, arguing that the secondary plunge also improved the metallurgical bonding of weak regions in RFSSW welds. Another publication, Y. Q. Zhao et al, Effects of sleeve plunge depth on microstructures and mechanical properties of friction spot welded alclad 7B04-T74 aluminum alloy, Materials & Design (1980-2015) 62:40-46 (2014), also used a secondary plunge, indenting the surface of their RFFSW joints by 0.2 mm while joining 1.9 mm alclad coated 7B04-T74 sheets. They concluded that plunge depths in excess of 2 mm necessitate the inclusion of this secondary plunge to eliminate annular groove defects attributed to material loss during joint formation.

As indicated above, despite RFSSW processes having been in development for more than a decade, they have seen only limited implementation and no large-scale applications, and the main prevention has been the time required to produce each joint so that it is mechanically sound. Moreover, a number of investigations into joining time have been conducted. Some authors have reported the total time in their work, and others have reported partial times. Regardless, a consensus from several authors suggests that the cycle time of RFFSW cannot be reduced without compromising joint quality and strength. One publication, Bruno Parra et al., An Investigation on Friction Spot Welding in Aa6181-T4 Alloy, Tecnologia em Metalurgia e Materiais 8 (3):184-190 (2011), argued that the high strain rate associated with welds faster than three seconds resulted in more weld defects (implying lower joint strength/quality). Moreover, they argued that weld duration was the parameter most relevant in providing input energy to create a bond between sheets. Another publication, Hong Gang Yang & Hai Jun Yang, Experimental investigation on refill friction stir spot welding process of aluminum alloys, 3rd International Conference on Mechanical Engineering, Industry and Manufacturing Engineering, MEIME 2013 (Jun. 22, 2013-Jun. 23, 2013), described welding of 2.0 mm sheets of AA6061-T6. They were unable to achieve strengths greater than 2.85 kN with a weld time of 0.8 seconds but did achieve 6.39 kN at 2.5 seconds. Particularly, they argued that at high speeds the material was not able to flow sufficiently as it could during slower welds. In a third publication, Andrzej Kubit et al., Failure mechanisms of refill friction stir spot welded 7075-T6 aluminium alloy single-lap joints, The International Journal of Advanced Manufacturing Technology 94 (9-12):4479-4491 (2017), joints were formed in AA7075-T6 with a 1.6 mm top sheet thickness and 0.8 mm bottom sheet thickness. They concluded that the duration of welding and the depth plunged during a weld were the two parameters with the greatest effect on joint quality. They also concluded that weld times or tool rotational speeds that are too great or too short can result in diminished weld quality, suggesting that weld times exist which may be sufficient for high quality welds to be produced—times that should not be decreased or increased.

However, the above and other definitive statements on the limits of the RFSSW process may be influenced by the machine capabilities associated with the respective authors. Moreover, since different RFSSW machines exist and have their respective design limitations, the capabilities of the RFSSW process should be understood to vary from machine to machine. It is in this context that statements or sentiments regarding the RFSSW process' capability of producing joints below a certain cycle time should be evaluated. Rather, the load cases and the phenomena intrinsic to the RFSSW process should influence the design and optimization of RFSSW machines.

For example, while the process steps of RFSSW may vary, certain tool kinematics define the basic design elements of an RFSSW joint. Regardless of which RFSSW machine is used, the time required to create an RFSSW weld is dependent on the desired parameters of the weld. Each stage of a weld may be composed individually, with tool motion determined by parameters such as linear tool feed-rates, tool rotational velocities, and by the distances tools are plunged into or retracted from the material. For example, experiments show that a RFSSW weld design, which can be described by process parameters such as tool feed rate, tool rotational velocity, and plunge depth, affects the loads and torques placed on the RFSSW tooling and machines during the welding process. An understanding of the tool kinematics in the RFSSW process is therefore key to an understanding of weld cycle time, and key to the development of welds that have faster cycle times. The total duration of all welding stages from the moment the toolset touches the top sheet until the tools cease contact with the weld material should be considered as the cycle time of the RFSSW process. For a manufacturer using a given material, an optimal weld design will contain the set of parameters that produces joints with an acceptable quality in an acceptable time.

In order for RFSSW to be widely adopted as a manufacturing process and see more implementation, rather than as an intriguing laboratory experiment, the cycle time of making a RFSSW joint must be reduced to an acceptable level. Cycle time is a metric that matters a great deal to manufacturers. Competing spot joining technologies such as riveting and resistance spot welding have succeeded in part because of their relatively brief cycle time; it is likely that RFSSW cycle times have been, and will continue to be, compared to the cycle times of these processes when being evaluated by manufacturers.

The inventors have quantified and interrogated the load cases of RFSSW processes in order to accurately design the conditions and acceptable machine characteristics to reduce weld cycle time. As mentioned above, others have shown that RFSSW is capable of producing satisfactory joint strength for various applications, but typically have not addressed the load cases undergone during the creation of a weld. This present disclosure enables the reduction of RFSSW cycle time, in part by identifying patterns or trends in the process load cases.

Some experts believe that reducing the time of the welding process will reduce the time in which diffusion is possible across areas critical to the RFSSW joint, thereby limiting the amount of stirring, and as such they claim the perceived lower limit on the RFSSW cycle time is due to the diffusion dependence of the RFSSW process. However, if RFSSW were performed at reduced cycle times using the steel and/or tungsten carbide tools that have been used in RFSSW so far, the life of such tools would be significantly reduced due to intermetallic growth. After a joint is made there is residue of the workpiece between the probe and shoulder in the tolerance area for the tooling. When welding aluminum, this residue can form an aluminum-rich intermetallic that can seize the probe and shoulder together, requiring more down time on the line. The inventors have developed an interfacial growth kinetics model to understand the critical time that a probe and shoulder can be in contact with each other at temperature before they seize, to be described below. First, however, testing of load cases and the results thereof will be discussed.

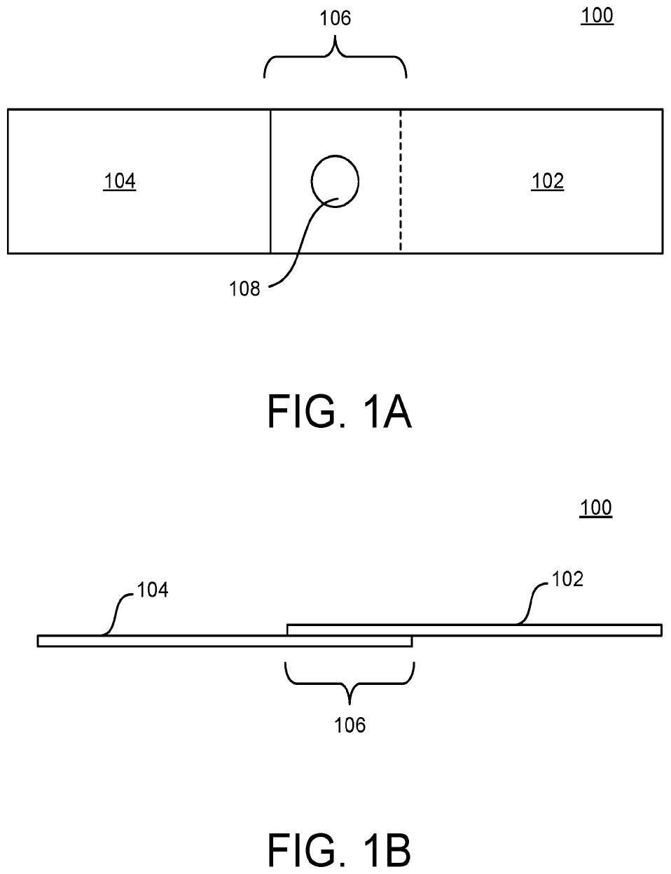

FIGS. 1A-1B show an example of a coupon arrangement 100. The coupon arrangement 100 can be used with one or more other embodiments described elsewhere herein. The coupon arrangement 100 can include two metal workpieces, here a coupon 102 and a coupon 104, to be welded together. The coupons 102 and 104 are positioned in a lap configuration with an overlap 106. An RFSSW joint 108 can be formed in any portion of the overlap 106. In some implementations, the RFSSW joint 108 is formed at a predefined distance from a lateral side of the coupon 102 and/or 104, or the RFSSW joint 108 is formed at a predefined distance from an end of the coupon 102 and/or 104. For example, the RFSSW joint 108 is formed in the center of the overlap 106. In some implementations, the coupons 102 and 104 can have different thicknesses from each other. In some implementations, the coupons 102 and 104 can have the same thickness. For example, the coupons 102 and 104 can have a thickness of at most about 2 millimeters (mm), such as a thickness of at most about 1.6 mm.

A number of instances of the coupon arrangement 100 were produced and welded together pairwise. The coupons 102 and 104 can be made from one or more metals. In some implementations, the coupons 102 and 104 are made of aluminum alloys. For example, in the present testing the coupons 102 and 104 were cut from sheets of the aluminum alloy referred to as AA5052-H36 using a hydraulic shear. The chemical composition of AA5052 is provided in Table 1 below, and the material properties of AA5052 is provided in Table 2 below. The coupons 102 and 104 were de-burred and then cleansed with an acetone wipe to remove dust and oils.

TABLE 1

| Chemical element | Content |
|---|---|
| Aluminum, Al | 95.7-97.7% |
| Chromium, Cr | 0.15-0.35% |
| Copper, Cu | <=0.10% |
| Iron, Fe | <=0.40% |
| Magnesium, Mg | 2.2-2.8% |
| Manganese, Mn | <=0.10% |
| Other, each | <=0.05% |
| Other, total | <=0.15% |
| Silicon, Si | <=0.25% |
| Zinc, Zn | <=0.10% |

TABLE 2

| Material property | Value | |
|---|---|---|
| Ultimate Tensile Strength | 276 | MPa |
| Yield Tensile Strength | 241 | MPa |
| Modulus of Elasticity | 70.3 | GPa |
| Shear Modulus | 25.9 | GPa |
| Shear Strength | 159 | MPa |

| | |
|---|---|
| Brinell Hardness | 73 |

Different weld parameters can be selected. In the present testing, weld parameters were selected based on published works relating to 5xxx series aluminum alloys. AA5052 is a ductile and work-hardening alloy that is readily die-formable in thin sheets and suitable for use in automobile panels and structures. The coupon arrangements 100 were pairwise organized in two stacks as follows: one stack contained respective pairs of coupons 102 and 104 that were both about 2.0 mm thick, and another stack contained respective pairs of coupons 102 and 104 that were both about 1.6 mm thick.

The RFSSW joints 108 were made in the coupon arrangements 100 using a high-speed RFSSW robotic end-effector machine. The technical specifications and capabilities of the machine are given in Table 3 below.

TABLE 3

| Specification | Value | |
|---|---|---|
| Max Spindle RPM | 6000 | RPM |
| Max Vertical Feed Rate | 3000 | mm/min |
| Max Downforce | 30 | kN |
| Clamping Force | Variable (9 kN max) | |
| Max Torque Capability | 48N-m | |
| Weight | 72 | kg |

Table 4 below shows the parameters used for the welds in the present tests. The welds were made with a hardened steel tool set with a probe diameter of 6 mm, a shoulder outer diameter of 9 mm, and a clamp outside diameter of 15 mm. The welds were made with shoulder plunge (that is, the probe was not plunged). Particularly, the welds were made by a shoulder plunge/probe retract stage, a refill stage (shoulder retract, probe return), and a secondary plunge stage as described in the introduction section. No preheat or dwell stages were employed. The tool rotational velocity was held constant throughout the entire weld until the toolset was removed from the coupon surface. The weld times shown in Table 4 comprise the total time of the shoulder plunge and refill stages, but do not contain the time of the secondary plunge stage (less than 0.1 seconds for each weld). Shoulder plunge stage and refill stage times were chosen to be equivalent. For example, the welds listed as 4 second welds comprised a 2 second shoulder plunge, a 2 second refill stage, and a rapid (less than 0.1 second) secondary plunge of 0.2 mm. The total cycle time of such welds should be considered to be less than 4.1 seconds.

TABLE 4

| Sheet Thickness | Plunge Depth | Weld Time | RPM | Weld Name |
|---|---|---|---|---|
| 2.0 mm to | 2.4 mm | 4 sec. | 2700 | A |
| 2.0 mm | | | 2300 | B |
| | | | 1700 | C |
| | | 3 sec. | 2700 | D |
| | | | 2300 | E |
| | | | 1700 | F |
| | | 2 sec. | 2700 | G |
| | | | 2300 | H |
| | | | 1700 | I |
| | | 1 sec. | 2700 | J |
| | | | 2300 | K |
| | | | 1700 | L |
| 1.6 mm to | 1.8 mm | 4 sec. | 1900 | M |
| 1.6 mm | | | 900 | N |
| | | 3 sec. | 1900 | O |
| | | | 900 | P |
| | | 2 sec. | 1900 | Q |
| | | | 900 | R |
| | | 1 sec. | 1900 | S |
| | | | 900 | T |

After welding, all specimens were pulled in unguided lap-shear tests using an INSTRON testing frame at a constant rate of 10 mm/min. Resultant load and extension data was collected from each tensile test at 625 Hz. The data enables a systematic investigation of the resultant forces and torques required to reduce cycle time from 4 seconds to 1 second according to the test plan shown in Table 4 above.

A comparison of the obtained test results with prior results is useful. With 2.0 mm sheets of 5083-O, Xu et al. implemented a secondary plunge stage as mentioned above, and completed a study on the effects of tool rotational velocity, shoulder plunge depth, and refill time (not the complete time, but the time of the refill stage) on joint quality as measured by lap-shear strength. In their study, they tested rotational velocities between 2300 and 2700 RPM, plunge depths of 2.2, 2.3, and 2.4 mm, and refill times of 1.5, 2.5, and 3.5 seconds. They were able to achieve strengths as high as 7.4 kN while welding at 2500 RPM, with a 2.4 mm plunge depth and a refill time of 1.5 seconds. After some analysis and modeling based on the collected data, they identified their parameters of 2300 RPM, 2.4 mm plunge depth, and 3.5 sec refill time to be ideal, and achieved strengths of 7.72 kN. Xu used tooling with a 9.0 mm shoulder.

While welding 1.5 mm sheets of 5052-O, Tier et al. conducted a similar study on the influence of weld parameters on joint quality. They conducted weld experiments at rotational velocities between 900 and 1400 RPM, at plunge depths of 1.45 and 1.55 mm, and with total times between 1.87 and 4.34 seconds. They achieved strengths between and 4.53 and 6.31 kN, with the peak 6.31 kN strength occurring at 900 RPM, 1.5 mm plunge depth, and 2.04 seconds. Tier used tooling with a 9.0 mm shoulder.

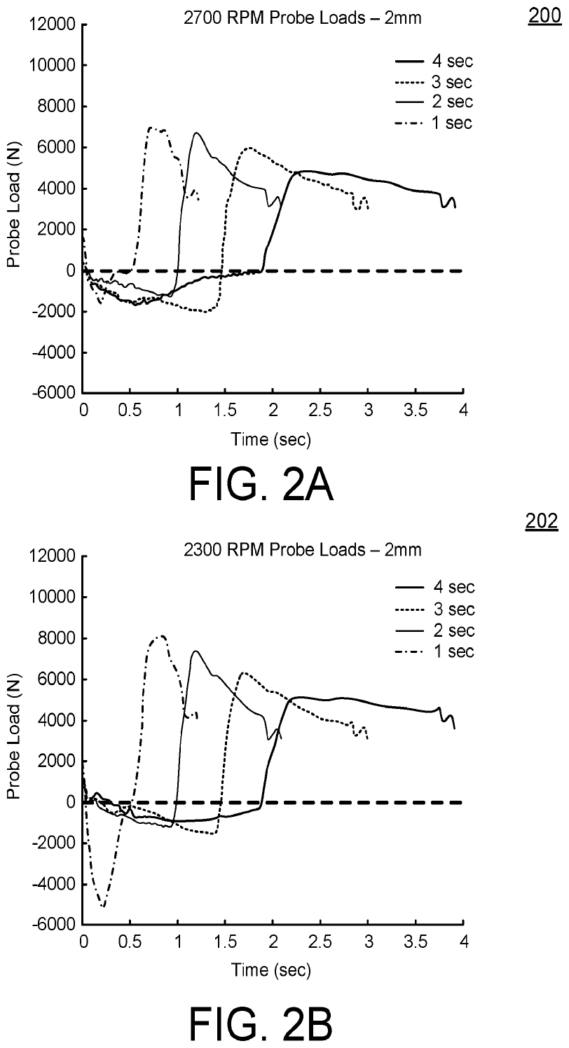

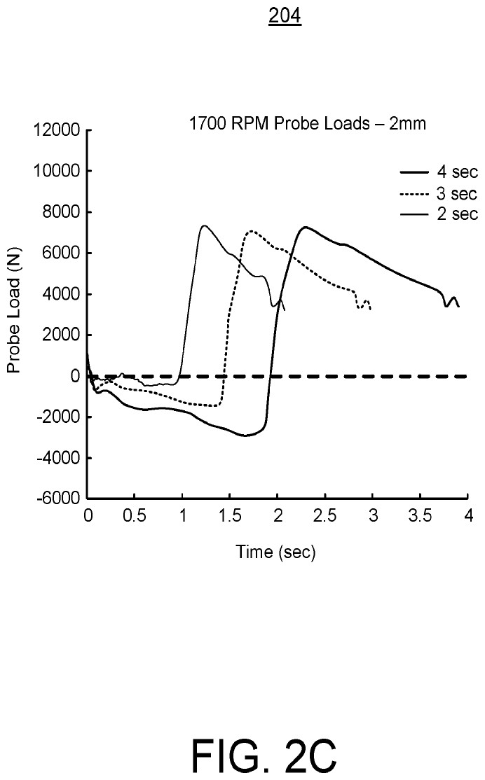

Some present results will now be described. FIGS. 2A-2C show example graphs 200, 202, and 204, respectively, of probe loads. The graph 200 shows probe loads for welds made at 2700 RPM with 2.0 mm coupons, with weld times ranging from one to four seconds. The graph 202 shows probe loads for welds made at 2300 RPM with 2.0 mm coupons, with weld times ranging from one to four seconds. The graph 204 shows probe loads for welds made at 1700 RPM with 2.0 mm coupons, with weld times ranging from one to four seconds.

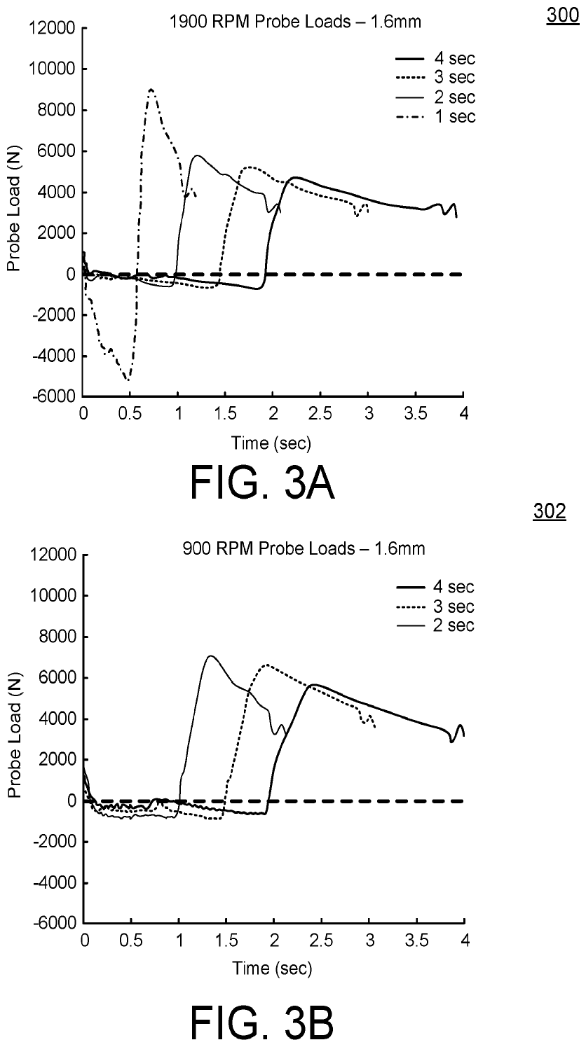

FIGS. 3A-3B show example graphs 300 and 302, respectively, of probe loads. The graph 300 shows probe loads for welds made at 1900 RPM with 1.6 mm coupons, with weld times ranging from one to four seconds. The graph 302 shows probe loads for welds made at 900 RPM with 1.6 mm coupons, with weld times ranging from two to four seconds.

Two trends are observed by comparing the plotted probe loads. The first is that as RPM decreases, the load placed on the tooling increases. This trend is true for all of the data points of a given cycle time, in both material thicknesses. The second trend is that as cycle time decreases, the load placed on the tooling increases. This trend is observable with all but two data points: the 4 second, 1700 RPM weld in graph 204 and the 3 second, 900 RPM weld in graph 302.

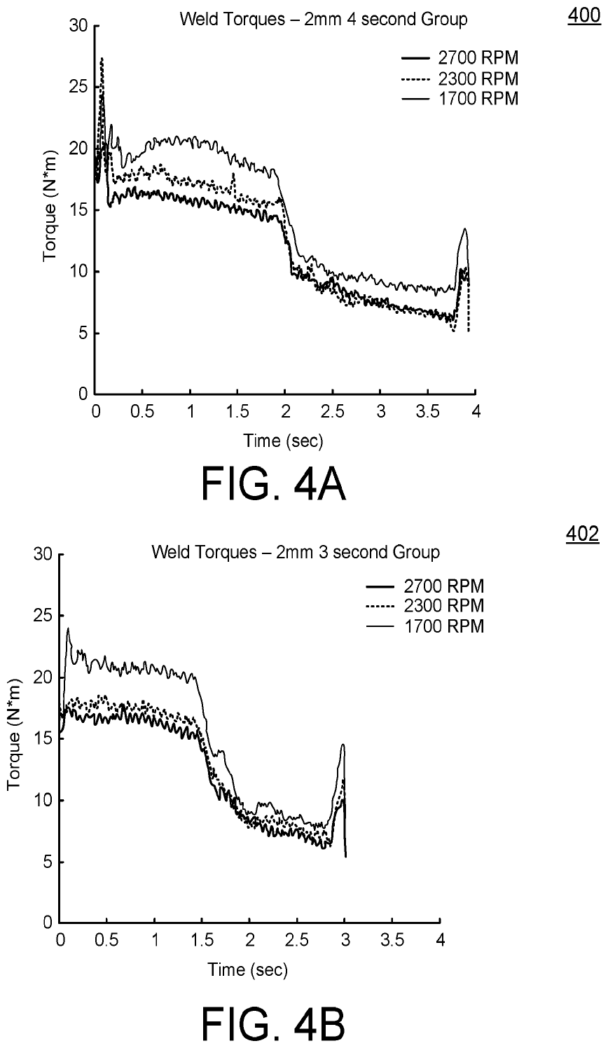

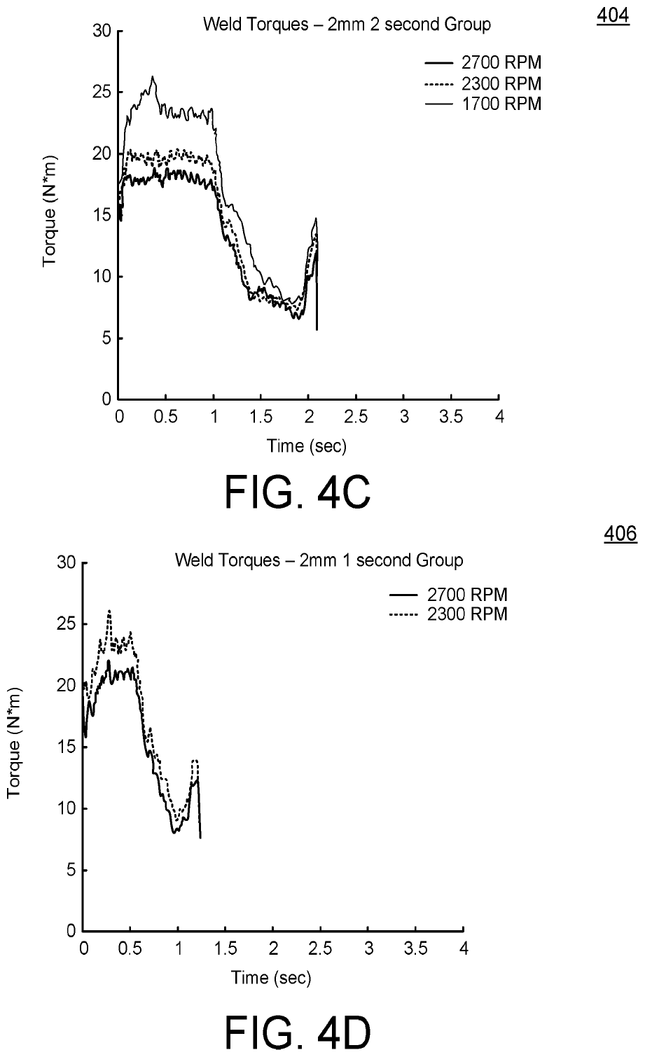

FIGS. 4A-4D show example graphs 400, 402, 404, and 406, respectively, of torques. The graph 400 shows weld torques for four-second welds with 2.0 mm coupons, with rotational speeds ranging from 1700 to 2700 RPM. The graph 402 shows weld torques for three-second welds with 2.0 mm coupons, with rotational speeds ranging from 1700 to 2700 RPM. The graph 404 shows weld torques for two-second welds with 2.0 mm coupons, with rotational speeds ranging from 1700 to 2700 RPM. The graph 406 shows weld torques for one-second welds with 2.0 mm coupons, with rotational speeds ranging from 2300 to 2700 RPM.

Nearly all of the spindle torque curves plotted share a similar profile. FIGS. 4A-4D show the recorded spindle torques from each 2 mm weld, sorted by cycle time. As the tooling first contacts the surface of the weld material, a sharp rise in torque is observed. After this initial peak, a slightly more stable value is reached for the remainder of the shoulder plunge stage. During the transition from the shoulder plunge stage to the refill stage, the torque falls sharply, until reaching a stable regime for the remainder of the refill stage. After the refill stage, another short peak is observed as the weld ends, resulting from the rapid secondary plunge sequence.

Like the probe load curves in FIGS. 2A-2C and 3A-B, the weld torque curves manifest two consistent trends. First, as RPM is decreased, spindle torque is observed to increase for each of the given cycle times. Slight deviations from this trend are observed as the proximity of the curves to one another increases during the transition to the refill stage. Second, as cycle time is decreased for a set RPM, the spindle torque increases. Both trends are most easily observed in the stable portion of the shoulder plunge stage (following the initial peak torque).

Both of the observed trends in the relationship between probe load and time are consistent with the intuitive expectation that a greater force is required to deform weld material when the weld duration or rotational tool velocity is reduced. Beyond confirming intuition, the observed and quantified load cases are valuable because they can inform the design of future RFSSW welds and RFSSW machines. For example, the collected data shows that at 2300 RPM in 2.0 mm material (graph 202 in FIG. 2A), in order to weld the 2.0 mm sheets in less than one second, machines must be capable of sustaining loads more than 1.5 times as high as when welding in 4 seconds. When welding at 1900 RPM in 1.6 mm sheets (graph 300 in FIG. 3A), the increase is nearly 2 times the force from a 4 second weld to a 1 second weld.

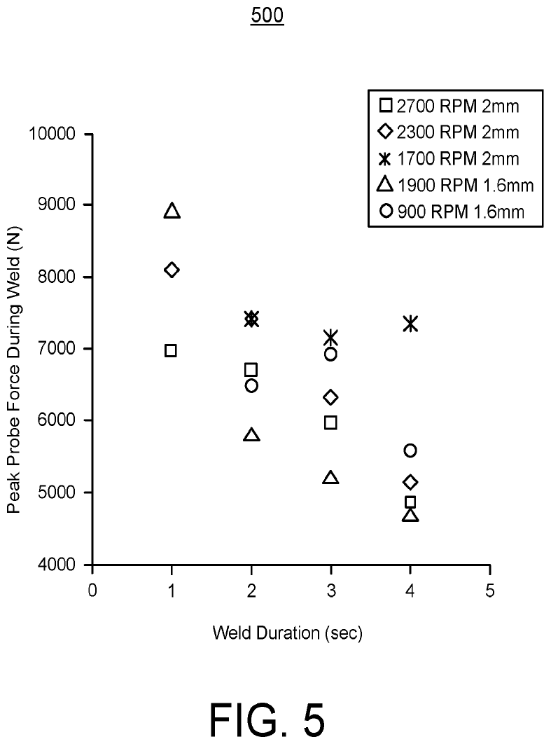

FIG. 5 shows an example graph 500 of peak probe force. The graph 500 contains a combined plot of all the peak probe forces collected during the welds. Particularly, the peak probe forces relate to welds performed at rotational speeds ranging from 1700 to 2700 RPM (all done with 2.0 mm coupons), and welds performed at rotational speeds ranging from 900 to 1900 RPM (all done with 1.6 mm coupons), and are arranged according to weld durations ranging from one to four seconds. This plot further emphasizes the mentioned trends in probe load and shows the two points which contradict the trend that load increases with cycle time. These two points (1700 RPM, 4 seconds; 900 RPM, 3 seconds) could suggest that the welding process loses stability at lower RPM. Further experimentation can be performed to advance a more definitive claim. The disruption of the observed trend occurs in the lowest rotational speed tested in each of the material thicknesses. The data points in these RPM sets appear to be less linearly connected than those at higher RPMs, which supports the opinion that the load cases are less stable/predictable at low RPM (at least with the presented machine setup). Other explanations for origin of these deviations could include the possibility of fluke measurements or variation in the load cases, unaccounted for in the present experimental design.

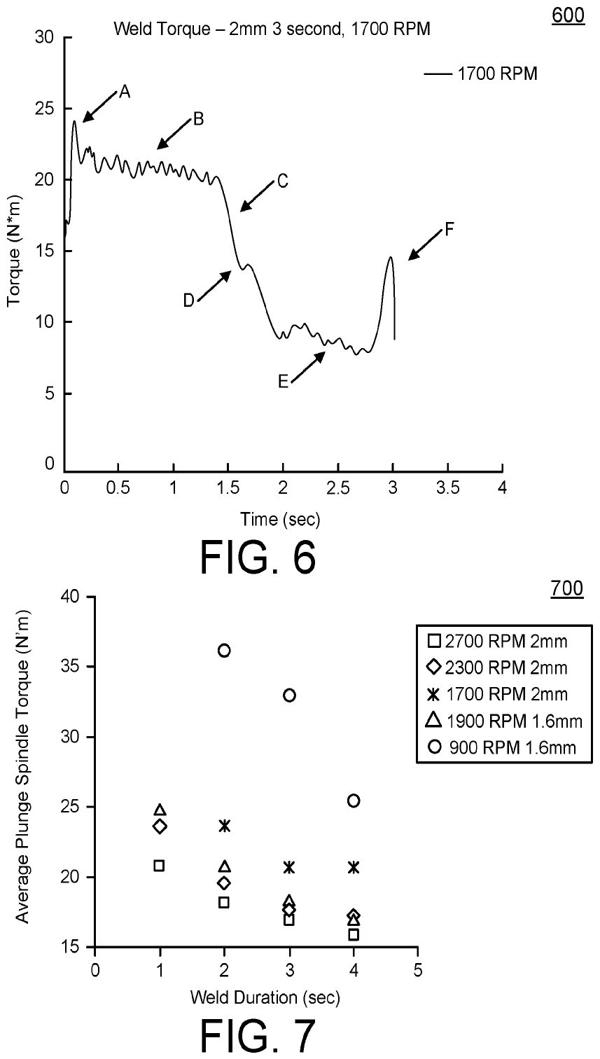

As mentioned earlier, the torque profiles collected during the welding process appear to follow a relatively uniform profile. FIG. 6 shows an example graph 600 of weld torque experienced during the 3-second, 2.0 mm weld at 2300 RPM (weld E in Table 4 above), annotated with markers displaying characteristic regions A through F. The torque profile of this weld was chosen to be representative, having all of the traits identified in the majority of the torque profiles. Marker A shows the peak torque achieved during the very beginning of the plunge sequence as the shoulder drives into the coupon surface. Marker B shows the next region, where a near constant torque is encountered during the remainder of the plunge sequence. Marker C marks a region occurring as the probe and shoulder have reversed directions at the beginning of the refill stage. The feature shown with Marker D is a step in the descending torque, likely occurring when the plane of the bottom of the shoulder crosses the plane of the bottom of the probe and the probe encounters resistance from the mass of stirred, flowing material (this step could be a phenomenon observable only in symmetric welds, future consideration of the load cases in non-symmetric weld designs may provide further insight). By marker E, during the refill stage, the torque reaches a second, near-constant value which terminates when the weld ends, and the secondary plunge is performed—marked by marker F and accompanied by a short peak. The similarity of the torque profiles and the consistent appearance of these identified characteristic regions in the various welds, suggests that analysis of weld torque profile can be a robust tool for informing weld or machine design.

A comparison with prior results is useful. Martin Reimann et al., Refilling termination hole in AA 2198-T851 by refill friction stir spot welding, Journal of Materials Processing Technology 245:157-166 (2017), produced similar plots of torque versus time while evaluating the potential for RFSSW to be used to eliminate weld termination holes with linear friction spot welding in aluminum alloy 2198-T851. They analyzed the separate shoulder and probe torques encountered while producing their RFSSW spots (though the effect of cycle time on shoulder/probe torque was not evaluated). In their study, it was demonstrated that the majority of the torque experienced in the RFSSW process is supplied by the shoulder tool, and is correlated to the plunge depth of the weld. Their approximately 7 second weld reached a relatively steady shoulder torque of 11N*m during the plunge stage and then diminished rapidly after the shoulder plunge stage was completed. When combined, Reimann's shoulder and probe torque plots share a similar profile to the total torque plots generated during this study, though the transition from region B to region E does not appear as sharply, nor does the step feature in region D. Because Reimann et al. welded over plugs of material placed in friction spot welding keyholes, the differences between the torque profiles collected in their study and the present work may be anticipated. The general absence of other published RFSSW torque data may prohibit more broad conclusions regarding the shape of these torque profiles from being made. Further research can be performed to determine whether the characteristic regions identified in this study are to be anticipated in other material stack ups or in other weld designs.

Moreover, average torque values from each weld were obtained by averaging the value of the torque in region B of the collected torque curves. Torques were averaged over a period of 0.125 seconds, centered halfway through the plunge stage. Average torque values are contained in Table 5 below, which shows force and torque values from the RFSSW machine during each of the conducted welds, accompanied by the recorded lap-shear strength (LSS) and extension at break for the tensile tests conducted on each weld. Welds L and T were abandoned after weld R exceeded the torque capabilities of the machine.

TABLE 5

| | | Average Torque | | |
|---|---|---|---|---|
| Weld | Peak Probe | During Plunge | | Extension at |
| Name | Force (kN) | (N*m) | LSS (kN) | Break (mm) |
| A | 4.86 | 15.9 | 6.55 | 17.8 |
| B | 5.14 | 17.3 | 6.89 | 17.7 |
| C | 7.34 | 20.7 | 7.11 | 7.6 |
| D | 5.97 | 16.9 | 7.00 | 7.4 |
| E | 6.33 | 17.6 | 7.39 | 26.5 |
| F | 7.14 | 20.8 | 7.50 | 15.1 |
| G | 6.70 | 18.2 | 7.49 | 22.7 |
| H | 7.41 | 19.6 | 7.56 | 19.1 |
| I | 7.39 | 23.7 | 7.54 | 13.9 |
| J | 6.96 | 20.8 | 6.29 | 12.6 |
| K | 8.09 | 23.8 | 6.36 | 11.3 |
| L | — | — | — | — |
| M | 4.70 | 17.1 | 5.37 | 38.9 |
| N | 5.60 | 25.5 | 6.44 | 28.3 |
| O | 5.23 | 18.4 | 6.33 | 30.8 |
| P | 6.49 | 33.0 | 6.60 | 28.5 |
| Q | 5.82 | 20.8 | 6.58 | 16.8 |
| R | 6.93 | 36.2 | 6.74 | 14.6 |
| S | 8.94 | 24.8 | 5.18 | 12.5 |
| T | — | — | — | — |

FIG. 7 shows an example graph 700 of average plunge spindle torque as a combined plot of torque during weld plunge vs weld duration. Particularly, the torques relate to welds performed at rotational speeds ranging from 1700 to 2700 RPM (all done with 2.0 mm coupons), and welds performed at rotational speeds ranging from 900 to 1900 RPM (all done with 1.6 mm coupons), and are arranged according to weld durations ranging from one to four seconds. From the perspective of machine design, these torque values are important because they represent the highest, sustained torques encountered during a weld. While motors and drive elements of a machine may be able to undergo brief peak torques greater than this value during a short duration, the average torques presented represent the design criteria necessary for running their respective welds.

After evaluating the joints produced for this study, an attempt was made to determine a more optimal parameter set for welds cycle times less than one second in the 2 mm material stack up, within the capabilities of the RFSSW end-effector. With some experimentation, and by observing the effect of parameter changes on the weld surface, the weld design was improved to produce joints in less than a second, with higher strengths than the previously produced one second joints. The design parameters of this optimal weld program are in Table 6 below, showing weld parameters of the optimized, sub-one second weld design. The commanded displacements of the tools have been altered, in addition to the duration of each stage.

TABLE 6

| Stage | Shoulder Command | Probe Command | Duration |
|---|---|---|---|
| Shoulder Plunge | −2.40 mm | 5.385 mm | .4 sec |
| Refill | 2.60 mm | −5.980 mm | .4 sec |
| Secondary Plunge | −0.40 mm | .595 mm | .1 sec |

Table 7 below contains the resultant force, torque, and tensile data from these welds, showing recorded weld data and tensile results for the sub-one second welds produced.

TABLE 7

| | | Average Torque | | |
|---|---|---|---|---|
| Weld | Peak Probe | During Plunge | | Extension at |
| Name | Force (kN) | (N*m) | LSS (kN) | Break (mm) |
| 1 | 10.61 | 26.7 | 7224.6 | 17.3 |
| 2 | 10.09 | 26.5 | 6706.4 | 17.6 |
| 3 | 9.59 | 24.7 | 7172.0 | 16.4 |
| 4 | 8.93 | 27.1 | 6899.8 | 14.1 |
| Average | 9.81 | 26.3 | 7000.7 | 16.4 |

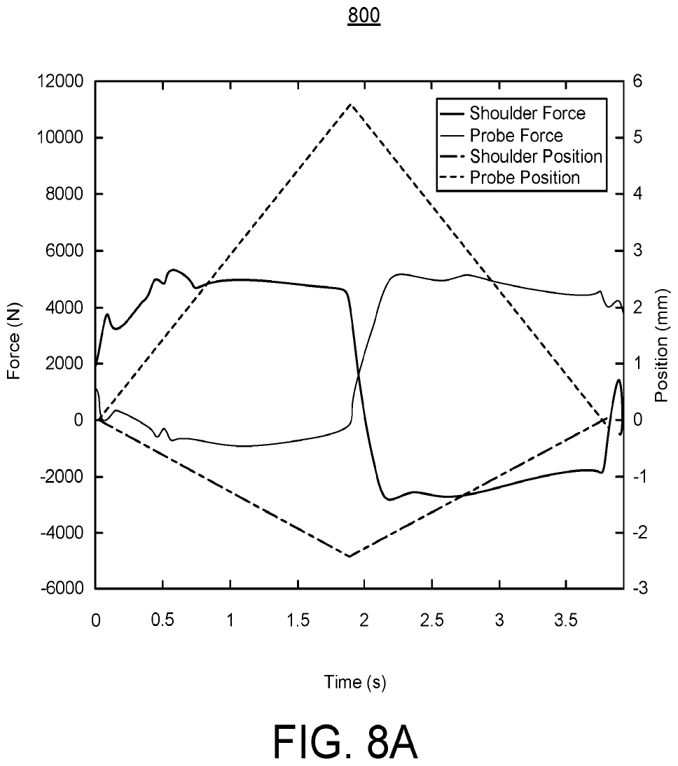

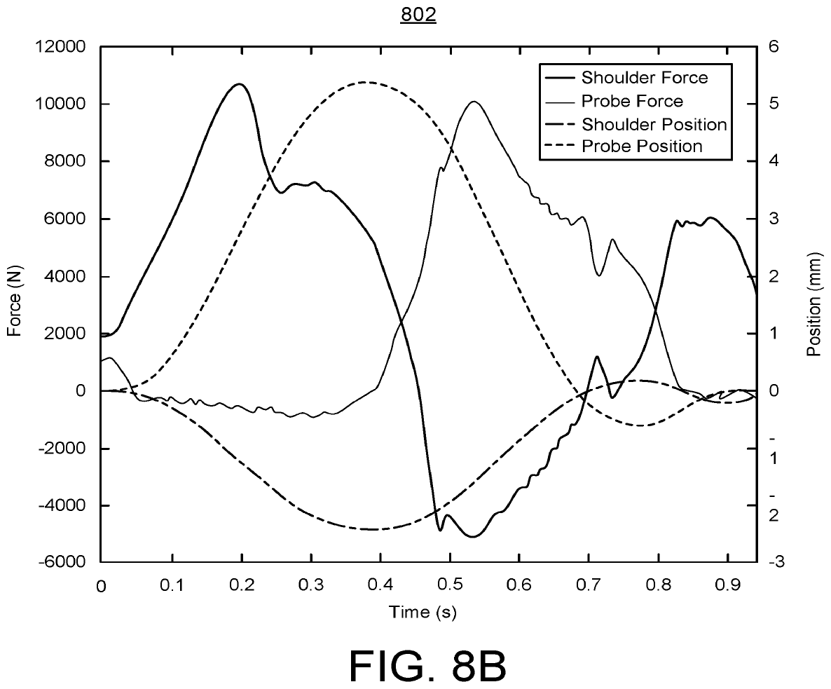

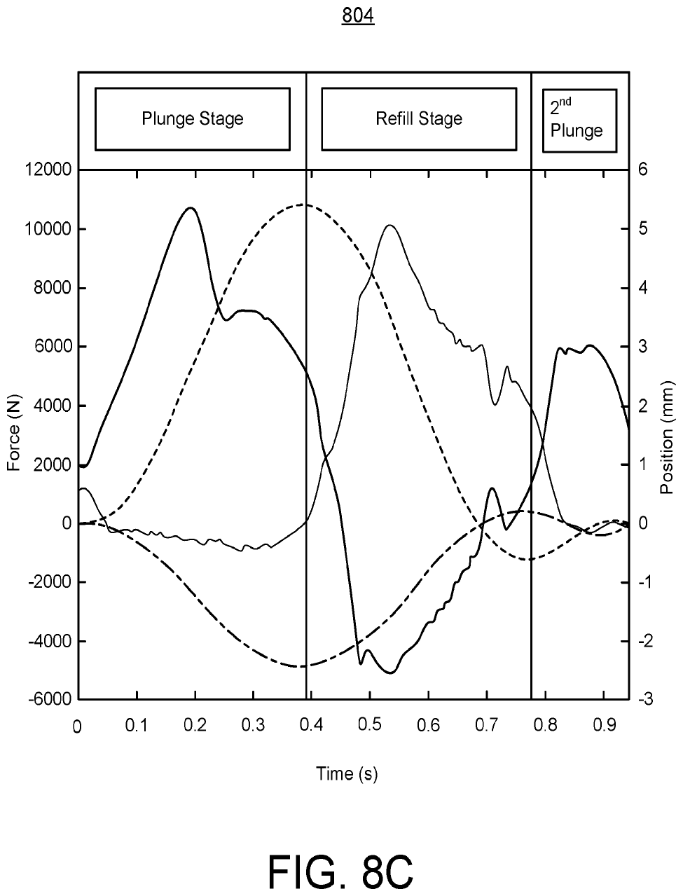

Comparison of a load case from a representative weld in this optimal group with a load case from the earlier group reinforces the understanding of the influence of cycle time on tool load. FIGS. 8A-8C show example graphs 800, 802, and 804, respectively, of shoulder and probe force. Graph 800 shows the shoulder and probe loads associated with a weld done at 2300 RPM with a four second total cycle time (weld B in Tables 4 and 5 above). Graph 802 shows the load case for the same shoulder and probe tooling during this optimized, sub-one-second weld. The magnitude of the peak shoulder force increases from 5.35 kN to 10.68 kN and the peak probe force increases from 5.14 kN to 10.09 kN. The average, mid-plunge torque for this optimal weld was 26.5N*m, up from 17.4N*m for weld B. This large increase conforms with the previously analyzed data—both the RPM and the cycle time were reduced and the expected increase in both torque and tooling load was observed. Graph 804 shows the same data as in the graph 802, annotated with labels for the regions of the plunge, refill, and secondary plunge stages, respectively.

In short, the examples described above show that quality spot welds can be formed also with a weld duration below the level commonly believed to be the lower limit. As indicated earlier, a greater weld speed places increased demands on the tooling, including by the occurrence of intermetallic growth, which will now be discussed.

Examples herein refer to intermetallic growth (sometimes referred to as “intermetallic” for short). Intermetallic growth includes the formation of any compound including metal on a surface of a tool (or a toolset) during friction stir welding, such as during RFSSW. The intermetallic can include residue of a workpiece that forms between the probe and shoulder of an RFSSW toolset. In some implementations that involve an aluminum workpiece, the intermetallic can include an aluminum-rich compound. For example, an intermetallic can include FeAl₃.

In order to validate the assumption that intermetallic compounds grow on a friction stir tool, a literature review was conducted. S. Y. Tarasov et al., A proposed diffusion-controlled wear mechanism of alloy steel friction stir welding (FSW) tools used on an aluminum alloy, Wear 2014; 130-34, performed a tribological study of a friction stir weld tool that was made of a X40CrMoV5-1 tooling steel with AMg5M aluminum as the work piece. Table 8 below shows these metals' respective compositions. These materials are similar to the Al 5754 sheet metal and H13 tool steel that is used in the experiments of the present disclosure. Differences include the Ti content in the AMg5M and slight variations in weight-percent (wt %) of some of the same elements.

TABLE 8
AMg5M

| Ele- | | | | | | | | | |
|---|---|---|---|---|---|---|---|---|---|
| ment | Al | Mg | Cr | Mn | Fe | Si | Zn | Cu | Ti |
| Wt % | Bal. | 2.6 − 3.6 | ≤0.3 | ≤0.5 | ≤0.4 | ≤0.4 | ≤0.2 | ≤0.1 | ≤0.15 |

X40CrMoV5-1

| Ele- | | | | | | | | | |
|---|---|---|---|---|---|---|---|---|---|
| ment | Fe | C | Cr | Mo | V | Mn | Si | P | S |
| Wt % | Bal. | 0.35 − 0.4 | 4.8 − | 1.2 − | .85 − | 0.25 − | 0.8 − | ≤0.03 | ≤0.02 |
| | | | 5.5 | 1.5 | 1.2 | 0.5 | 1.2 | | |

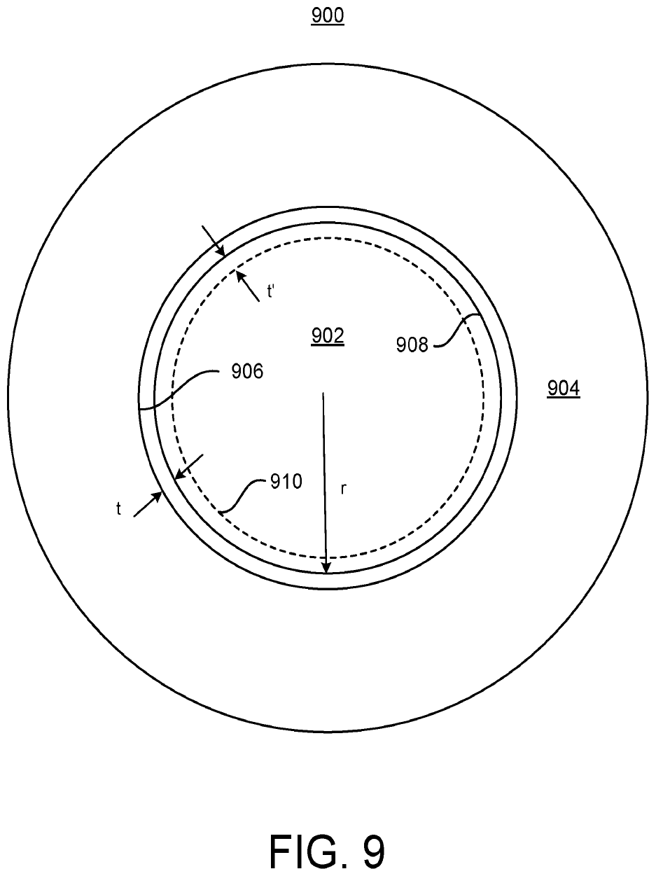

To solve for the critical time of intermetallic growth a diffusion limited coarsening model was developed. The system of interest can include the probe and the workpiece aluminum that is in between the probe and the shoulder. FIG. 9 shows a bottom view of an example of a RFSSW toolset 900. The RFSSW toolset 900 includes a probe 902 nested inside a cylindrical cavity 906 of a shoulder 904. The probe 902 is currently shown in a retracted state, such that the shown surface of the probe 902 is situated further away from the viewer (i.e., into the drawing) than is the shown surface of the shoulder 904. An intermetallic 908 is shown on the cylindrical surface of the cylindrical cavity 906. A depletion zone 910 is defined radially inside of the intermetallic 908.

Assuming that the volume of iron that is used in the intermetallic is the same as the depletion zone volume the concentrations can be equated in Equation 1 below:

C_{equ}(2π)rth=C_{act}(2π)rt′h, (1)

where the height (h) of this ring is 4 mm (length of the probe retraction height), r is the radius of the probe 902 (here 3 mm), t is the thickness of the intermetallic 908, t′ is the thickness of the depletion zone 910, C_{act} is the actual concentration of iron through the depletion zone from the shoulder 904 to the intermetallic interface, and C_{equ} is the concentration of iron in the intermetallic 908 (here 25%). Simplification of Equation 1 gives a relation of the intermetallic thickness to the depletion thickness in Equation 2 below:

t′=C_{equ}(C_{act})⁻¹t. (2)

Using the number of Fe atoms that are added to the intermetallic, the rate of atoms per time can be defined as the surface area of flux multiplied by the flux of Fe according to Equation 3 below:

$$\frac{d n}{d τ} = {A}_{D} {J}_{D} , \qquad ( 3 )$$

where A_{D}=2πrh and J_{D}=D_{Fe}^{Al}(C_{act}−C_{equ})/t′. Then the volume growth of the intermetallic is defined by the volume of an Fe atom multiplied by the number of Fe atoms per unit time. Substituting in A_{D} and J_{D} gives Equation 4 below where Ω is the atomic volume of an Fe atom:

$$\frac{d V}{d τ} = Ω ( 2 π r h ) [ {D}_{F e}^{A l} ( \frac{{C}_{act} - {C}_{e q u}}{{t}^{′}} ) ] . \qquad ( 4 )$$

Next, the volume of the intermetallic 908 is defined by the same parameters as in Equation 1. Then, taking the partial derivative with respect to time (τ) gives Equation 5 below:

$$\frac{dV}{d τ} = 2 π r h \frac{dt}{d τ} . \qquad ( 5 )$$

Equating Equations 4 and 5, simplifying and integrating gives the final thickness prediction according to Equation 6 below, where D_{Fe}^{Al} is the diffusivity of Fe in Al and τ is time in seconds:

$$t = \sqrt{2 Ω ( {D}_{F e}^{Al} ) τ \frac{{C}_{act} - {C}_{e q u}}{{C}_{e q u} / {C}_{act}}} . \qquad ( 6 )$$

Equation 6 above relates the growth of the interface with respect to time and diffusion coefficients. The diffusion coefficient is temperature dependent. To find diffusion coefficients of Fe in Al at welding temperatures another literature review has been performed. R Li et al., Enhanced atomic diffusion of Fe—Al diffusion couple during spark plasma sintering, Scripta Materialia 2016:105-08, includes a compilation of diffusion studies of Fe in Al and reported activation energies for this process. The data from these plots were then used to extrapolate diffusion coefficients in the desired temperatures. Predicted thicknesses were calculated for both the extrapolated values from the 2006 diffusivites and the 2007.

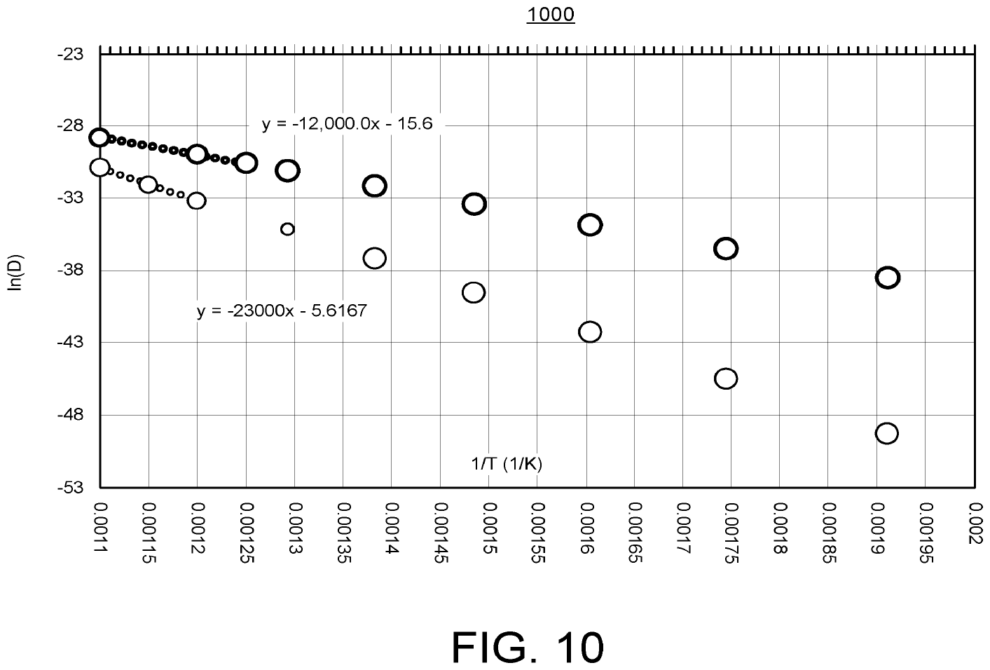

FIG. 10 shows an example graph 1000 of diffusion coefficients data. The graph 1000 includes diffusion coefficients data from the literature and the extrapolated data at lower welding temperatures.

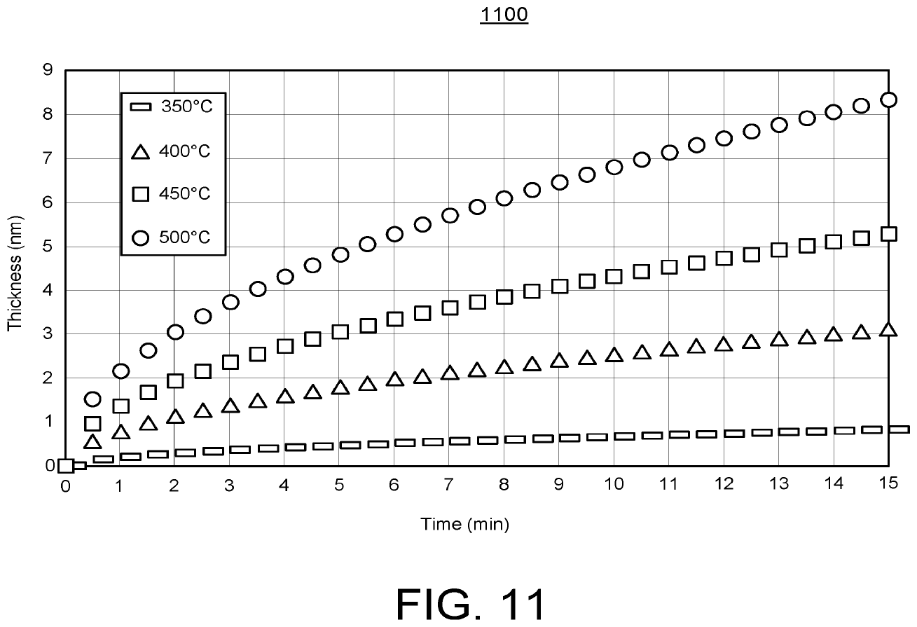

Using equation 6 above, and the extrapolated diffusivity coefficients, intermetallic thickness predictions were calculated. These predictions follow the characteristics of the diffusion limited growth regime because the growth of the interface has a square root of time relationship. However, the experimental values of the intermetallic thickness are three orders of magnitude higher than the present predictions, around 5 μm instead of 5 nm at 10 minutes' time, V. Jindal et al., Reactive diffusion in the roll bonded iron-aluminum system, Materials Letters 2006:1758-61. Because the thicknesses were so small in comparison to the experimental data the 2007 extrapolated diffusivities were used to report the intermetallic thickness in the present disclosure. FIG. 11 shows an example graph 1100 of predictions of FeAl₃ thickness. The 2007 study diffusivity coefficients were used because they were higher at lower temperatures resulting in thicker intermetallics, which better coincides with the experimental results. The intermetallic thickness in the RFSSW case may be thinner because of non-ideal diffusion conditions. The materials used in RFSSW are not nearly pure Fe or Al. The alloying elements in the welding case would dampen the diffusion of Fe in the Al. This would result in a thinner intermetallic, however the data suggests that even with alloying the resultant thickness of the intermetallic layer would be three orders of magnitude smaller. Despite these differences in the magnitude, both this model and the experimental results suggest that the time needed for an intermetallic to grow troubling amounts would be under three minutes of rest time. Depending on the actual temperature of the tooling even one minute could result in seized tooling. To better estimate the time to seize a controlled seize experiment can be performed to calculate the activation energies required to grow certain thicknesses of intermetallic that seizes the tool.

That is, the above examples show that intermetallic growth occurs in RFSSW tools and becomes more severe at greater loads and temperatures. To combat intermetallic growth, a model can be developed and analyzed, for example as described below.

To model diffusion in the RFSSW weld, one region of the weld can be considered. During the shoulder plunge stage, an interface is created between the area deformed and displaced by the shoulder tool, and the area of the parent sheets just beyond the area under the shoulder. After joining is complete, this interface separates the Heat Affected Zone (HAZ) and Thermo-Mechanically Affected Zone (TMAZ) of the weld. Diffusion will be evaluated at this interface for simplicity, though it is anticipated that diffusion across other regions in the RFSSW joint have significant effects on joint quality and strength.

In this model, it will be assumed that the TMAZ/HAZ interface is cleanly sheared during the shoulder plunge, and that it is oxide-free—allowing intimate contact between the parent material and the plasticized weld material during the refill stage. Diffusion time across the TMAZ/HAZ interface will be estimated as a portion of the duration of the refill stage. Considering the flow of the plasticized material that fills the TMAZ, it is more likely that regions along the TMAZ/HAZ interface at different distances from the coupon surface will achieve varying diffusion times. For simplicity it was decided that diffusion time would be estimated as a constant three-fourths of the total refill time. Symmetric weld designs with two cycle times will be considered: a four second weld consisting of a two second plunge stage and a two second refill stage, and a one second weld consisting of a 500-millisecond plunge stage and a 500-millisecond refill stage. Therefore, the four second weld will be considered to have a diffusion time of 1.5 seconds; the one second weld will be considered to have a diffusion time of 0.375 seconds.

For simplicity, in this model, material properties are considered for pure aluminum rather than for a particular alloy system.

The following examples relate to derivation of the model. With the stated simplifying assumptions in mind, a rough model for diffusion across the RFSSW TMAZ/HAZ interface can begin by considering the general relationship between diffusivity D and the energy required for diffusion to take place:

$$D = {D}_{0} {e}^{( \frac{- G}{k T} )} , \qquad ( 7 )$$

where D₀ is the pre-exponential self-diffusivity at set conditions, and G is the energy needed for self-diffusion to take place. G can be broken up into enthalpic and entropic contributions by the relationship:

G=U+VP−TS, (8)

where the internal energy U and the activation volume multiplied by pressure VP could be combined to be the weld parameter specific enthalpy of migration of a vacancy (since the self-diffusion of aluminum is vacancy mediated).

Substituting equation 8 into equation 7 gives:

$$D = {D}_{0} {e}^{( \frac{- U - V P + T S}{k T} )} . \qquad ( 9 )$$

The desired outcome of the model is to have a version of Equation 9 above that expresses the diffusivity D as a function of the weld cycle time (t_{C}). Because the internal energy and activation volume are functions of temperature and pressure, and as shown in prior data, temperature and pressure are functions of the chosen cycle time (assuming all other weld parameters such as RPM are constant), this equation would resemble:

$$D ( {t}_{C} ) = {D}_{0} {e}^{( \frac{- {G}_{( tc )}}{{kT}_{( tc )}} )} = {D}_{0} {e}^{\frac{( - {U}_{( tc )} - {P}_{( tc )} {V}_{( tc )} + {T}_{( tc )} S}{{kT}_{( tc )}}} . \qquad ( 10 )$$

Several unknown relationships have been introduced. One can pursue the modeling of these relationships for temperature T and pressure P as functions of cycle time, and then pursue the relationships of energy U and activation volume V as a function of the modeled T and P. As another example, one can use data collected from the welding machine to estimate T and P for different cycle times (other parameters constant), and published empirical data can be used to estimate the effect of T and P on U and V and subsequently D for the desired weld conditions. Some authors have attempted to model the relationship between temperature/pressure and weld parameters, with little success.

From published diffusivity data of aluminum, diffusivities at multiple temperatures and pressures can be used to estimate the activation energy and the volume of activation. Equation 9 above can be manipulated such that:

$$\begin{matrix}D = {D}_{0} {e}^{( \frac{- U}{k T} )} {e}^{( \frac{- V P}{k T} )} {e}^{( \frac{S}{k} )} , \\ and & ( 11 ) \\ ln ( D ) = ln ( {D}_{0} ) - \frac{U}{k T} - \frac{VP}{k T} + \frac{S}{k} . & ( 12 )\end{matrix}$$

Differentiating equation 12 with respect to pressure demonstrates how the activation volume can be estimated for a given temperature and pressure:

$$\frac{\partial ln ( D )}{\partial P} = 0 - 0 - \frac{V}{k T} + 0 , \\ \frac{\partial ln ( D )}{\partial P} = - \frac{V}{k T} , \\ and \\ V = - k T \frac{\partial ln ( D )}{\partial P} . \qquad ( 13 )$$

To estimate the activation energy, equation 12 above can also be differentiated with respect to the inverse of temperature, yielding:

$$\frac{\partial ln ( D )}{\partial \frac{1}{T}} = 0 - \frac{U}{k} - \frac{VP}{k} + 0 , \\ \frac{\partial ln ( D )}{\partial \frac{1}{T}} = - \frac{U + VP}{k} , \\ and \\ U + V P = - k \frac{\partial ln ( D )}{\partial \frac{1}{T}} . \qquad ( 14 )$$

Thus, U and V can be estimated for a given temperature and pressure from experimental data. Equation 11 above can also be re-arranged so that the pre-exponential diffusivity D₀ is combined with the entropic term

$${e}^{( \frac{S}{k} )}$$

such that:

$$D = {D}_{0}^{′} {e}^{( \frac{- U}{k T} )} {e}^{( \frac{- V P}{k T} )} , \qquad ( 15 )$$

where

$${D}_{0}^{′} = {D}_{0} {e}^{( \frac{S}{k} )} .$$

This enables equation 12 above to be rewritten as:

$$ln ( D ) = - \frac{U + V P}{k} ( \frac{1}{T} ) + ln ( {D}_{0}^{′} ) , \qquad ( 16 )$$

which is of the familiar form y=mx+b, enabling ln(D₀′) to be estimated easily (e^{ln(D}^{_{0′}}⁾) from the intercept of a linear regression of the diffusivities for a given pressure versus time. Predicting diffusivity with this value will therefore require the assumption that ln(D₀′) is independent of pressure and temperature.

Knowing the pressure and temperature associated with a given cycle time, and after using equation 16 above to predict D₀′ and equations 14 and 13 above to predict U and V, one can use equation 15 above to predict D for that cycle time. The general point-source approximation for diffusion distance, λ, can be used to then predict the diffusion distance in the modeled system:

λ≈\sqrt{4Dt}. (17)

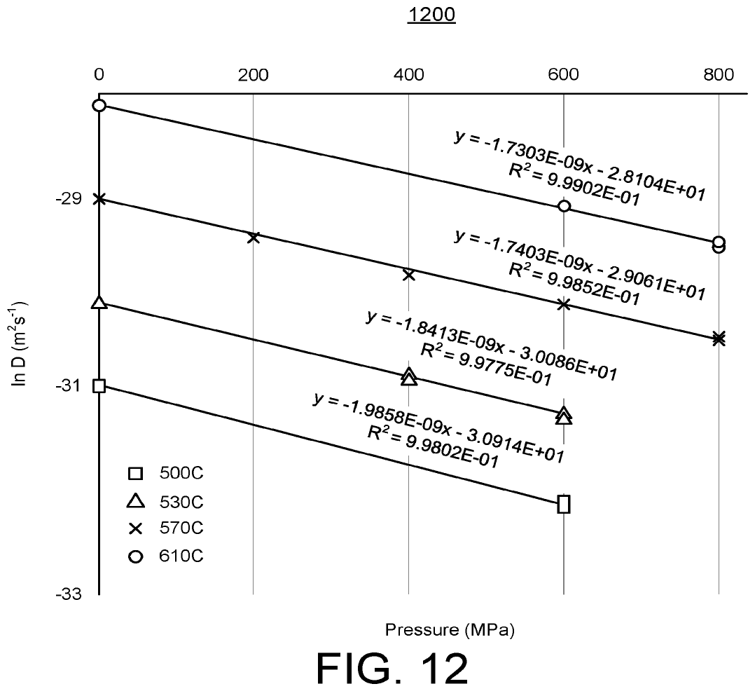

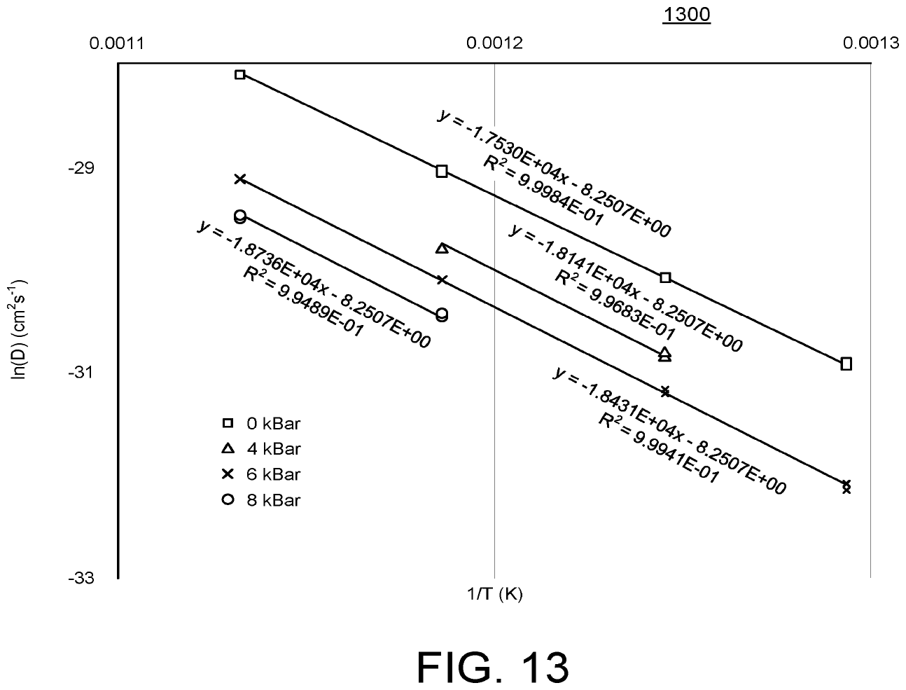

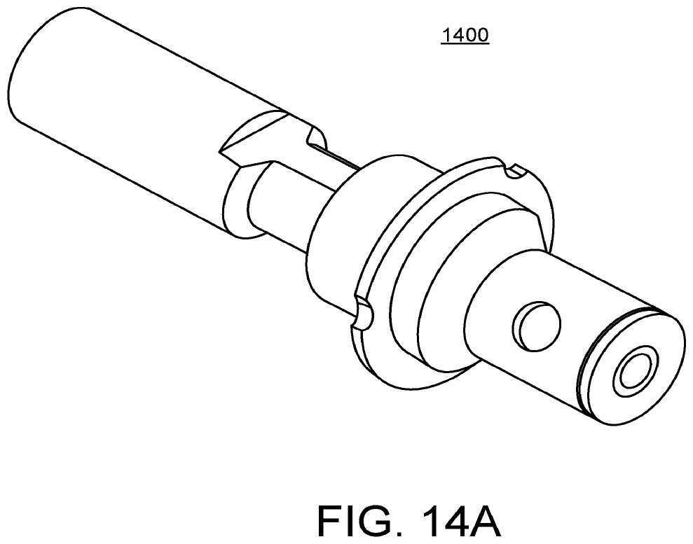

The following examples relate to implementing empirical data in the model. Using the data found in M. Beyeler & Y. Adda, Détermination des volumes d'activation pour la diffusion des atomes dans l'or, le cuivre et l'aluminium, Journal de Physique 29 (4), 345-352 (1968), for the self-diffusivity experiments of aluminum, the plots shown in FIGS. 12 and 13 can be generated, with linear regressions used to show the correlation of these terms to their corresponding governing equations. FIG. 12 shows an example graph 1200 of predicted diffusivity data. FIG. 13 shows an example graph 1300 of predicted diffusivity data.

From FIGS. 12 and 13 and Equation 13 above, the activation volumes can be estimated for the plotted temperatures. From FIGS. 12 and 13 and Equation 14 above, the internal energies can be estimated for the temperatures and pressures. These volumes and energies are contained in Tables 9, 10, and 11 below. It was found while deriving U and V that both U and V are effectively constant. Fluctuation occurs in these estimated values, but without a pattern or trend. Thus, it has been assumed that for the purposes of this model, the average U and V values can be used for pressures and temperatures in the range of interest. The energy of activation U+VP has been shown to vary with temperature (as expected), but U and V have not been so shown (at least not demonstrably).

TABLE 9

| P (bar) | P (Pa) | EA (J) | U (J) |
|---|---|---|---|
| 0 | 1.0E+05 | 2.42E−19 | 2.420E−19 |
| 4 | 4.0E+08 | 2.50E−19 | 2.422E−19 |
| 6 | 6.0E+08 | 2.54E−19 | 2.420E−19 |
| 8 | 8.0E+08 | 2.59E−19 | 2.421E−19 |

TABLE 10

| T | V* (m³) |
|---|---|
| 610 | 2.10979E−29 |
| 570 | 2.02587E−29 |
| 530 | 2.04176E−29 |
| 500 | 2.11974E−29 |

TABLE 11

| Average V (m³) | Average U (J) | Do′ (m²/s) |
|---|---|---|
| 2.07E−29 | 2.421E−19 | 2.61E−04 |

During experimentation, it was found while welding AA5052-H36 at 2300 RPM, with a −2.4 mm plunge depth, that welds with a cycle time of four seconds experience approximately 5 kN of force during the refill stage, while welds with a one second cycle time experienced approximately 12 kN of force. By dividing this force by the area of the probe (here 2.8×10-5 m²) pushing down on the material in the TMAZ, one can estimate the pressure during the refill stage to be approximately 1.8×10⁸ Pa (1.8 kBar) for a four second weld, and 4.24×10⁸ Pa (4.24 kBar) for a 1 second weld. After welding experiments, it has also been estimated that the temperature during a 4 second weld is as high as 500° C., and the temperature of a one second weld is as high as 450° C.

Using these measured pressure and temperatures, along with the constant values of D₀′, U, and V, the final equation to predict the mean diffusion distance at the TMAZ/HAZ interface can therefore be written:

$$λ \approx \sqrt{4 t ( {D}_{0}^{′} {e}^{( \frac{- U}{k T} )} {e}^{( \frac{- V P}{k T} )} )} , \qquad ( 18 )$$

where D₀′=2.61×10-4 m²s⁻¹, U=2.421×10⁻¹⁹ J, V=2.07×10⁻²⁹ m³, and where T and P are known experimentally for a given weld parameter.

Thus the diffusivity for the four and one second welds can be estimated:

$$D = {D}_{0}^{′} {e}^{( \frac{- U}{k T} )} {e}^{( \frac{- V P}{k T} )} \approx 5.25 \times {10}^{- 14} {m}^{2} {s}^{- 1} ( for a weld with a 4 second cycle time ) , \\ and$$

$$D = {D}_{0}^{′} {e}^{( \frac{- U}{k T} )} {e}^{( \frac{- V P}{k T} )} \approx 1.86 \times {10}^{- 14} {m}^{2} {s}^{- 1} ( for a weld with a 1 second cycle time ) .$$

The mean diffusion distances, λ, can be estimated:

λ≈\sqrt{4Dt}≈5.610×10⁻⁷ m (for a weld with a 4 second cycle time), and

λ≈\sqrt{4Dt}≈1.670×10⁻⁷ m (for a weld with a 1 second cycle time).

It is now observable, with the presented model, that the predicted ratio of λ for a one second weld to λ for a four second weld is 0.298. That is, the diffusion distances are of the same order in magnitude, but not equal.

The following examples relate to implications of the model. The implication that the diffusion distances for the described circumstances are similar, but not equal highlights the sensitivity of the self-diffusivity to temperature. It also highlights the very low impact that pressure has on self-diffusion in this system. Even though the shorter welds have less time for diffusion to take effect, and are slightly cooler than the long welds, the diffusion distance is not reduced by an extreme amount. This effect, in the case of the optimized welds described earlier, must not have been sufficient enough to significantly reduce weld strength.

In the specific cased analyzed, with a four and a one second weld, the model demonstrates that there may be a difference in the mean diffusion length, however the model does not definitively validate the assumption that faster weld cycle times have shown poor strengths because of a difference in the diffusion distance across the HAZ/TMAZ interface. Further investigation into the relationship between diffusion across the HAZ/TMAZ interface may be conducted, in order to determine if there is a critical diffusion distance that should be achieved in order to obtain acceptable weld strengths. Also, because of the sensitivity of this model to temperature, accurate temperature measurements are important in successfully predicting the mean diffusion distance; further experimental investigations on weld temperature may also be conducted.

In view of the above results and analysis, it appears that the obtainable shorter weld durations can result in a relatively greater growth of intermetallic on the RFSSW toolset that had not been contemplated at the previous, significantly longer weld cycle times. To address durability of the RFSSW toolset for the increased load and temperature, attempts can therefore be made to make an RFSSW tool that includes a superabrasive material. Generally, making an RFSSW toolset from a superabrasive material will decrease the resistance between any of the tools in the RFSSW toolset, if other parameters are unchanged. However, the superabrasive material will also reduce the friction between the tool(s) and the workpiece if other parameters are unchanged, a friction that is central to friction stir welding.

Examples herein refer to one or more superabrasive materials. A superabrasive material as used herein can refer to any material that is generally referred to as being superabrasive for one or more purposes. A superabrasive material can be characterized at least in part in terms of its hardness. Any of multiple tests for hardness can be used. In some implementations, a superabrasive material is characterized by its Vickers hardness test. A superabrasive material can have a Vickers hardness of at least about 20 gigapascals (GPa). In some implementations, a superabrasive material can have a Vickers hardness of at least about 40 GPa. In some implementations, a superabrasive material can have a Vickers hardness of at least about 60 GPa. In some implementations, a superabrasive material can have a Vickers hardness of at least about 80 GPa. In some implementations, a superabrasive material can include one or more forms of diamond. In some implementations, a superabrasive material can include one or more forms of cubic boron nitride (CBN).

Examples herein refer to a material including diamond. Any of multiple forms of diamond can be included. In some implementations, monocrystalline diamond can be included. In some implementations, polycrystalline diamond can be included. Synthetic diamond can be manufactured using one or more processes. For example, diamond can be manufactured by chemical vapor deposition; by a high-temperature, high-pressure technique; by explosive detonation; and/or by ultrasound cavitation. A crystal structure of a diamond material can include a face-centered cubic lattice with two carbon atoms in the basis.

Examples herein refer to a material including CBN. A material that includes CBN can include a compound of boron and nitrogen. Any of multiple forms of CBN can be included. In some implementations, monocrystalline CBN can be included. In some implementations, polycrystalline CBN can be included. CBN can be manufactured using one or more processes. For example, CBN can be manufactured by bonding CBN grains with a ceramic material; by converting hexagonal boron nitride; by chemical vapor deposition; by a high-temperature, high-pressure technique; by explosive detonation; and/or by ultrasound cavitation. A CBN material can have a Zincblende crystal structure. A CBN material can have a sphalerite crystal structure.

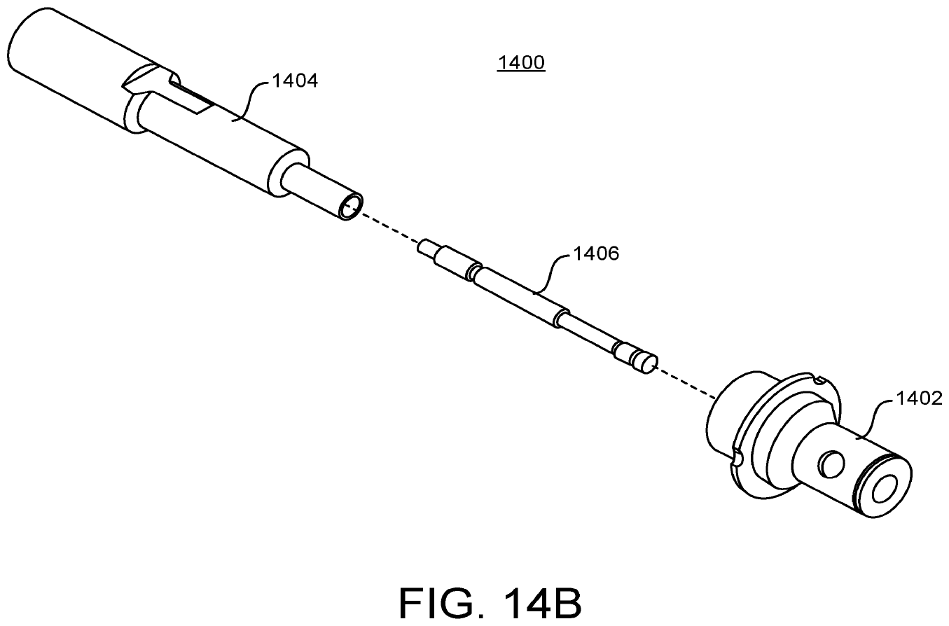

FIGS. 14A-14B show an example of an RFSSW toolset 1400. The RFSSW toolset 1400 can be used in, or together with, one or more other examples described elsewhere herein. The RFSSW toolset 1400 includes a clamp 1402, a shoulder 1404, and a probe 1406. The RFSSW toolset 1400 can include more or fewer tools than shown. In some implementations, the clamp 1402 can have at least a portion made of a superabrasive material. For example, the clamp 1402 can have at least a portion made of the same superabrasive material as the shoulder 1404 and/or the probe 1406. The shoulder 1404 is concentric with, and articulable relative to, the clamp 1402. The shoulder 1404 can be positioned in a cylindrical cavity of the clamp 1402. In some implementations, the shoulder 1404 can have at least a portion made of a superabrasive material. For example, the shoulder 1404 can have at least a portion made of the same superabrasive material as the clamp 1402 and/or the probe 1406. The probe 1406 is concentric with, and articulable relative to, the shoulder 1404. The probe 1406 can be positioned in a cylindrical cavity of the shoulder 1404. In some implementations, the probe 1406 can have at least a portion made of a superabrasive material. For example, the probe 1406 can have at least a portion made of the same superabrasive material as the clamp 1402 and/or the shoulder 1404.

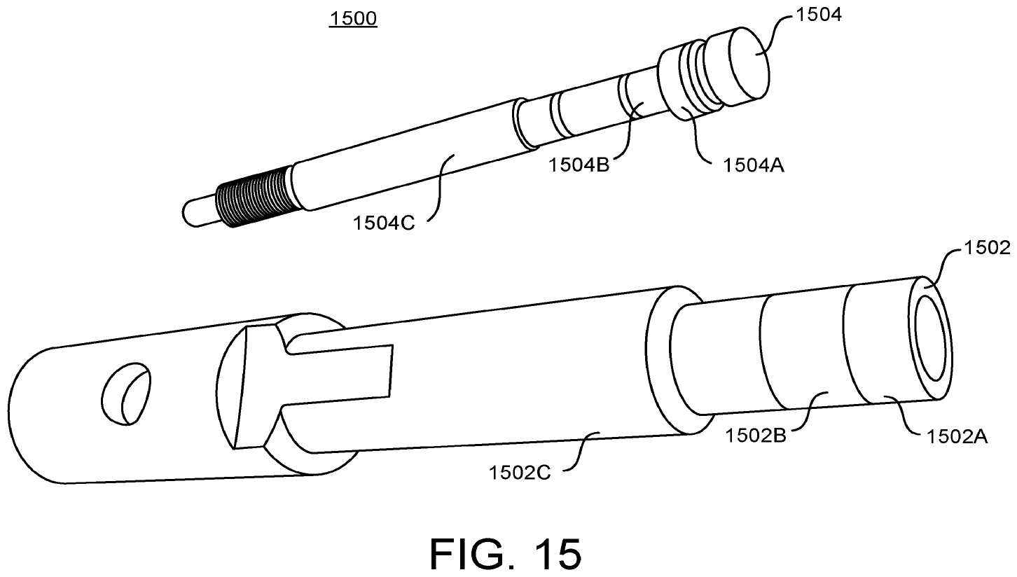

FIG. 15 shows an example of an RFSSW toolset 1500. The RFSSW toolset 1500 can be used in, or together with, one or more other examples described elsewhere herein. The RFSSW toolset 1500 includes a shoulder 1502 and a probe 1504. The RFSSW toolset 1500 can include more or fewer tools than shown. The shoulder 1502 can include a shoulder tool 1502A, an intermediate portion 1502B, and a shoulder body 1502C. In some implementations, the shoulder tool 1502A can have at least a portion made of a superabrasive material. In some implementations, the shoulder tool 1502A can be grown onto the intermediate portion 1502B. For example, the intermediate portion 1502B can include tungsten. In some implementations, the intermediate portion 1502B can be attached to the shoulder body 1502C. For example, the intermediate portion 1502B can be brazed onto the shoulder body 1502C. The shoulder body 1502C can be made of a material other than a superabrasive material. For example, the shoulder body 1502C can be made of steel.

The probe 1504 can include a probe tool 1504A, an intermediate portion 1504B, and a probe body 1504C. In some implementations, the probe tool 1504A can have at least a portion made of a superabrasive material. In some implementations, the probe tool 1504A can be grown onto the intermediate portion 1504B. For example, the intermediate portion 1504B can include tungsten. In some implementations, the intermediate portion 1504B can be attached to the probe body 1504C. For example, the intermediate portion 1504B can be brazed onto the probe body 1504C. The probe body 1504C can be made of a material other than a superabrasive material. For example, the probe body 1504C can be made of steel.

Attaching a tool having at least a portion of a superabrasive material to another tool portion (e.g., of a different material) can be different than merely coating the other tool portion with the superabrasive material. In some implementations, the boundary or interface between a superabrasive material and the other tool portion can be a plane (as opposed to, say, a three-dimensional boundary/interface). For example, the superabrasive material can be characterized as being positioned entirely to one side (e.g., a left side or a right side) of the plane boundary, and the other material can be characterized as being positioned entirely to the opposite side (e.g., a right side or a left side) of the plane boundary. The superabrasive portion can be a solid portion.

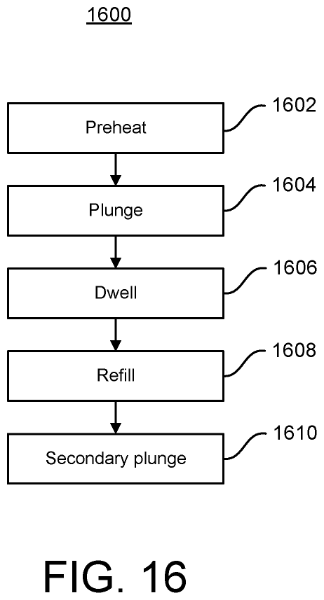

FIG. 16 shows an example of a method. The method can be performed on, or together with, one or more other examples described elsewhere herein. More or fewer operations than shown can be performed. Two or more operations can be performed in a different order unless otherwise indicated.

At operation 1602, a preheat can be performed. In some implementations, the coupons 102 and 104 (FIG. 1) can be preheated as part of an RFSSW process. For example, the shoulder and/or probe of the RFSSW toolset 1400 (FIG. 14) and/or the RFSSW toolset 1500 (FIG. 15) can be rotated against a workpiece to perform preheating.

At operation 1604, a plunge can be performed with an RFSSW toolset. In some implementations, one of a shoulder and a probe is plunged into a workpiece during rotation. For example, the shoulder or the probe of the RFSSW toolset 1400 (FIG. 14) and/or the RFSSW toolset 1500 (FIG. 15) can be plunged.

At operation 1606, a dwelling can be performed. In some implementations, the plunged one of the shoulder and probe of the RFSSW toolset 1400 (FIG. 14) and/or the RFSSW toolset 1500 (FIG. 15) can be dwelled after being plunged. For example, this can improve the quality of the weld.

At operation 1608, a refill can be performed. In some implementations, the refill includes advancing another one of the shoulder and the probe toward the workpiece during rotation. For example, the other of the shoulder or the probe of the RFSSW toolset 1400 (FIG. 14) and/or the RFSSW toolset 1500 (FIG. 15) can be advanced toward the workpiece.

At operation 1610, a secondary plunge can be performed. In some implementations, one or both of a shoulder and a probe is plunged into a workpiece during rotation after the refill. For example, the shoulder and/or the probe of the RFSSW toolset 1400 (FIG. 14) and/or the RFSSW toolset 1500 (FIG. 15) can be plunged.

It will also be understood that when an element, such as a layer, a region, or a substrate, is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element or layer, there are no intervening elements or layers present. Although the terms directly on, directly connected to, or directly coupled to may not be used throughout the detailed description, elements that are shown as being directly on, directly connected or directly coupled can be referred to as such. The claims of the application may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

While certain features of the described implementations have been illustrated as described herein, many modifications, substitutions, changes and equivalents will now occur to those skilled in the art. It is, therefore, to be understood that claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A refill friction stir spot welding tool comprising:
a clamp;
a shoulder concentric with, and articulable relative to, the clamp; and
a probe concentric with, and articulable relative to, the shoulder;
wherein each of the clamp, the shoulder and the probe have at least a portion made of a superabrasive material.

2. The refill friction stir spot welding tool of claim 1, wherein another portion of the refill friction stir spot welding tool is made of a material other than the superabrasive material.

3. The refill friction stir spot welding tool of claim 2, wherein the other material includes steel.

4. The refill friction stir spot welding tool of claim 1, wherein the superabrasive material comprises diamond.

5. The refill friction stir spot welding tool of claim 4, wherein the diamond comprises polycrystalline diamond.

6. The refill friction stir spot welding tool of claim 4, wherein the diamond comprises synthetic diamond.

7. The refill friction stir spot welding tool of claim 1, wherein the superabrasive material comprises cubic boron nitride.

8. The refill friction stir spot welding tool of claim 7, wherein the cubic boron nitride comprises polycrystalline cubic boron nitride.

9. The refill friction stir spot welding tool of claim 1, wherein the superabrasive material has a Vickers hardness of at least about 20 gigapascals (GPa).

10. The refill friction stir spot welding tool of claim 9, wherein the superabrasive material has a Vickers hardness of at least about 60 GPa.

11. The refill friction stir spot welding tool of claim 10, wherein the superabrasive material has a Vickers hardness of at least about 80 GPa.

12. A method comprising:
with a refill friction stir spot welding tool, plunging one of a shoulder or a probe into a workpiece during rotation, the refill friction stir spot welding tool comprising a clamp, a shoulder concentric with, and articulable relative to, the clamp, and a probe concentric with, and articulable relative to, the shoulder, each of the clamp, the shoulder and the probe having at least a portion made of a superabrasive material; and
after plunging, refilling by advancing another one of the shoulder or the probe toward the workpiece during rotation.

13. The method of claim 12, further comprising preheating the workpiece before plunging, the preheating performed by contacting the workpiece with the refill friction stir spot welding tool during rotation.

14. The method of claim 12, further comprising dwelling the refill friction stir spot welding tool at the workpiece after the plunging.

15. The method of claim 12, further comprising performing a secondary plunge after the refilling.

16. The method of claim 12, wherein the superabrasive material comprises diamond.

17. The method of claim 12, wherein the superabrasive material comprises a polycrystalline superabrasive material.

18. The method of claim 12, wherein the superabrasive material comprises cubic boron nitride.

19. The method of claim 12, wherein the superabrasive material has a Vickers hardness of at least about 40 GPa.

20. The method of claim 19, wherein the superabrasive material has a Vickers hardness of at least about 80 GPa.
